(19) United States
(12) Patent Application Publication
(10) Pub. No.: US 2025/0063342 A1
(43) Pub. Date: Feb. 20, 2025

(54) CAMOUFLAGING USER DATA

(71) Applicant: Frontier Communications Holdings, LLC, Norwalk, CT (US)

(72) Inventor: John VALDEZ, Copper Canyon, TX (US)

(73) Assignee: Frontier Communications Holdings, LLC, Norwalk, CT (US)

(21) Appl. No.: 18/450,778

(22) Filed: Aug. 16, 2023

(51) Int. Cl. H04W 12/02; H04W 12/037; H04W 76/11

(52) U.S. Cl. CPC H04W 12/02; H04W 12/037; H04W 76/11

(57) ABSTRACT

Disclosed herein are system, method, and computer program product embodiments for camouflaging user data. A user device (e.g., a mobile device, a computing device, an Internet-of-Things (IoT) device, a profile manager configured with a device, etc.) may identify a first data pattern for a first device at a first location and a second data pattern for a second device at a second location. The first data pattern may be modified to indicate an identifier of the second device and an identifier of the second location. A request from the first device for content from a content source may be modified to indicate an identifier of a third device, an identifier of a third location, and/or the like. A data stream may be output that includes the modified first data pattern and the modified request for the content.

### BACKGROUND

Internet users are tracked by multiple methods to identify them. These methods include applications installed on mobile phones and other user devices, cookies utilized by websites, routers used for network access, and/or servers (e.g., domain name servers, etc.) that facilitate website access. However, privacy for users while browsing the Internet is crucial for digital security and preventing unauthorized access and/or sharing of sensitive information. User profiling and/or information collection through browser tracking is often an inconspicuous, but unwanted, method of targeting users for advertisement campaigns, information solicitations, and more. Users are unable to mitigate, counteract, and/or prevent user profiling.

### BRIEF DESCRIPTION OF THE DRAWINGS

The accompanying drawings are incorporated herein and form a part of the specification.

FIG. 1 is a block diagram of a system for camouflaging user data, according to some aspects of this disclosure.

FIG. 2 is a block diagram of a system for camouflaging user data, according to some aspects of this disclosure.

FIG. 3 is a block diagram of a system for camouflaging user data, according to some aspects of this disclosure.

FIG. 4 is a flowchart illustrating a method for camouflaging user data, according to some aspects of this disclosure.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for camouflaging user data (e.g., a communication profile, globally unique identifier (GUID) information, etc.).

According to some aspects of this disclosure, a first data pattern (e.g., browsing history and/or activity, previous communications, etc.) for a first device (e.g., a mobile device, a computing device, and Internet-of-Things (IoT) device, etc.) at a first location and a second data pattern for a second device at a second location may be identified. The first data pattern may be modified to indicate an identifier (e.g., hostname, etc.) of the second device and an identifier (e.g., source IP address, etc.) of the second location. A request from the first device for content (e.g., a resource, an HTML file, a web page, an application, etc.) from a content source (e.g., a web server, an application server etc.) may be modified to indicate an identifier of a third device, an identifier of a third location, and/or the like. A data stream may be output that includes the modified first data pattern and the modified request for the content.

According to some aspects of this disclosure, a plurality of simulated requests for a plurality of content items associated with a plurality of content sources may be generated based on including, but not limited to, the first data pattern, the second data pattern, and/or the like.

According to some aspects of this disclosure, the data stream output by the first device (and/or a data stream output by the second device, etc.) may include the plurality of simulated requests. For example, according to some aspects of this disclosure, a trained machine learning model may use user and/or device credentials (e.g., password information, login information, globally unique identifiers (GUIDs), etc.) used to browse content sources (e.g., web traffic check sites, etc.) to generate a plurality (e.g., 10-10,000+, etc.) digital twins (e.g., simulated clones of a user and/or user device, etc.) to obfuscate true/actual user and/or user device communication traffic. The simulated traffic and/or digital twins may thwart user/device communication tracking, for example, such as user/device communication tracking used for profiling, advertisement targeting, ad campaigns, data tracking, statistical analysis, and/or the like. In other words, according to some aspects of this disclosure, the system, apparatus, device, method and/or computer program product embodiments, and/or combinations and sub-combinations thereof for camouflaging user data enable users that desire to maintain a level of anonymity to avoid being profiled and targeted for advertising and idea suggestion.

According to some aspects of this disclosure, the system, apparatus, device, method and/or computer program product embodiments, and/or combinations and sub-combinations thereof for camouflaging user data service operate to improve Internet security and/or the transmission of secure data.

According to some aspects of this disclosure, the system, apparatus, device, method and/or computer program product embodiments, and/or combinations and sub-combinations thereof for camouflaging user data assist users in avoiding “search-bubble” and/or “bubble effect” bias resulting from the inherent, personalized nature of Internet search engines that tailor results according to derived user preferences obtained through profiling. These and other technological advantages are described herein.

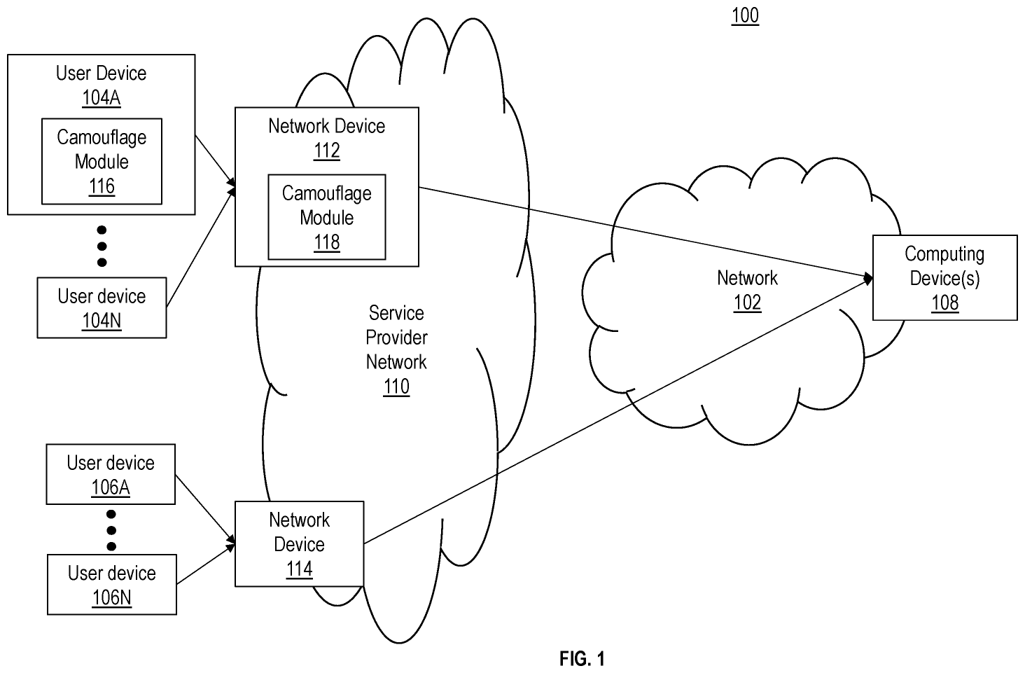

FIG. 1 is a block diagram of a system 100 for camouflaging user data, according to some aspects of this disclosure. According to some aspects of this disclosure, system 100 is merely an example of one suitable system environment and is not intended to suggest any limitation as to the scope of use or functionality of aspects described herein. Neither should the system 100 be interpreted as having any dependency or requirement related to any single module/component or combination of modules/components described therein. According to some aspects of this disclosure, aspects of system 100 may include and/or operate with software, hardware, combinations thereof, and/or the like.

According to some aspects of this disclosure, system 100 may include a network 102. According to some aspects of this disclosure, network 102 may include a packet-switched network (e.g., internet protocol-based network), a non-packet-switched network (e.g., quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). According to some aspects of this disclosure, network 102 may include public networks, private networks, wide area networks (e.g., Internet), local area networks, and/or the like. According to some aspects of this disclosure, network may include a content access network, content distribution network, and/or the like. According to some aspects of this disclosure, network 102 may provide and/or support communication from telephone, cellular, modem, and/or other electronic devices to and throughout system 100. For example, system 100 may include user device(s) 104A-N and user device(s) 106A-N in communication with a computing device(s) 108 via network 102.

According to some aspects of this disclosure, user device(s) 104A-N and user device(s) 106A-N may be in communication with computing device(s) 108 via a service provider network 110 (e.g., Frontier Communications® Network, etc.) in communication with network 102. According to some aspects of this disclosure, service provider network 110 may include one or more wired and/or wireless networks via which user device(s) 104A-N and user device(s) 106A-N communicate and/or receive content. According to some aspects of this disclosure, service provider network 110 may include any hardware and/or software for facilitating and/or supporting a local area network (LAN), a private network, a secure communication network, and/or the like. According to some aspects of this disclosure, service provider network 110 may include a cellular network, the Public Land Mobile Network (PLMN), a second-generation (2G) network, a third-generation (3G) network, a fourth generation (4G) network (e.g., a long term evolution (LTE) network), a fifth generation (5G) network, and/or another network. According to some aspects of this disclosure, service provider network 110 may include a wide area network (WAN), a metropolitan area network (MAN), an ad hoc network, an intranet, a fiber optic-based network (e.g., a fiber optic service (FiOS) network), and/or a combination of these or other types of networks. According to some aspects of this disclosure, service provider network 110 may be part/portion of network 202, communicate with network 102, and/or include shared/interworking hardware/software with network 102.

According to some aspects of this disclosure, network devices 112 and 114 may be in communication and/or facilitate communication with service provider network 110. For example, according to some aspects of this disclosure, network devices 112 and 114 may facilitate the connection of a device, such as user device(s) 104A-N and user device(s) 106A-N, respectively, to service provider network 110. According to some aspects of this disclosure, one or more of network devices 112 and 114 may be configured as a router and/or the like. According to some aspects of this disclosure, one or more of network devices 112 and 114 may be configured as wireless access points (WAP).

According to some aspects of this disclosure, network devices 112 and 114 may be configured to support and/or enable local area network (LAN) and/or the like. According to some aspects of this disclosure, network devices 112 and 114 may be and/or include dual-band wireless access points. For example, according to some aspects of this disclosure, network devices 112 and 114 may be configured with first service set identifiers (SSIDs) (e.g., associated with a user network or private network) to function as a local network for a particular user or users (e.g., network device 112 for user device(s) 104A-N and network device 114 for user device(s) 106A-N, etc.). According to some aspects of this disclosure, network devices 112 and 114 may be configured with second service set identifier (SSIDs) (e.g., associated with a public/community network or a hidden network) to function as a secondary network or redundant network for connected communication devices.

According to some aspects of this disclosure, network devices 112 and 114 may be configured with one or more identifiers. According to some aspects of this disclosure, one or more identifiers may be or relate to an Internet Protocol (IP) Address IPV4/IPV6 or a media access control address (MAC address) or the like. According to some aspects of this disclosure, one or more identifiers may be unique identifiers for facilitating communications on a physical network segment. According to some aspects of this disclosure, network devices 112 and 114 may be configured with distinct identifiers, for example, distinct identifiers that indicate the physical location of network devices 112 and 114. For example, according to some aspects of this disclosure, user device(s) 104A-N and user device(s) 106A-N may be associated with different locations (e.g., homes, offices, stores, etc.) and/or supported by different user profiles. According to some aspects, network devices 112 and 114 may be configured (e.g., via camouflage module, etc.) to camouflage user profiles, device identifiers, user indicators, browsing and/or communication traffic and/or information, and/or the like.

According to some aspects of this disclosure, user device(s) 104A-N and user device(s) 106A-N may include, but are not limited to, mobile devices, computing devices, Internet-of-Things (IoT) devices, smart devices, set-top boxes, display devices, content management and/or access devices, and/or any other devices capable of communicating with computing device 104. According to some aspects of this disclosure, user device(s) 104A-N and user device(s) 106A-N may each include a communication element for providing an interface for a user to interact with the user device(s) 104A-N, the user device(s) 106A-N, and/or computing device(s) 108. According to some aspects of this disclosure, the communication element may be any interface for presenting and/or receiving information to/from the user, such as user feedback. An interface may be a communication interface such as a web browser (e.g., Internet Explorer®, Mozilla Firefox®, Google Chrome®, Safari®, or the like). Other software, hardware, and/or interfaces may be used to provide communication between the user and one or more of the user device(s) 104A-N, the user device(s) 106A-N, and/or computing device(s) 108. According to some aspects of this disclosure, the communication element may request or query various files from a local source and/or a remote source. According to some aspects of this disclosure, the communication element may transmit data to a local or remote device such as computing device(s) 108.

According to some aspects of this disclosure, user device(s) 104A-N and user device(s) 106A-N may each be associated with a user identifier or device identifier. According to some aspects of this disclosure, the device identifier may be any identifier, token, character, string, or the like, for differentiating one user or user device (e.g., the user device(s) 104A-N and user device(s) 106A-N) from another user or user device. According to some aspects of this disclosure, the device identifier may identify a user or user device as belonging to a particular class of users or user devices. According to some aspects of this disclosure, the device identifier may comprise information relating to the user device such as a manufacturer, a model or type of device, a service provider associated with the user device, a state of the user device, a locator, and/or a label or classifier. According to some aspects of this disclosure, other information may be represented by the device identifier.

According to some aspects of this disclosure, the device identifier may include an address element and/or a service element. According to some aspects of this disclosure, the address element may comprise or provide an internet protocol address, a network address, a media access control (MAC) address, an Internet address, or the like. According to some aspects of this disclosure, the address element may be relied upon to establish a communication session between the user device (e.g., the user device(s) 104A-N and user device(s) 106A-N) and computing device(s) 108 or other devices and/or networks. According to some aspects of this disclosure, the address element may be used as an identifier or locator of the user device. According to some aspects of this disclosure, the address element may be persistent for a particular network, for example, such as service provider network 110.

According to some aspects of this disclosure, the service element of the device identifier may include an identification of a service provider (e.g., a service provider associated with service provider network 110, etc.) associated with the user device(s) 104A-N and user device(s) 106A-N and/or with a class of user device(s) 104A-N and user device(s) 106A-N. According to some aspects of this disclosure, the class of the user device(s) 104A-N and user device(s) 106A-N may be related to a type of device, a capability of the device, a type of service being provided, and/or a level of service (e.g., business class, service tier, service package, etc.). According to some aspects of this disclosure, the service element may comprise information relating to and/or provided by a service provider (e.g., a service provider associated with service provider network 110, etc.) that is providing or enabling data flow such as communication services to of the user device(s) 104A-N and user device(s) 106A-N. According to some aspects of this disclosure, the service element may comprise information relating to a preferred service provider for one or more particular services relating to a user device. According to some aspects of this disclosure, the address element may be used to identify and/or retrieve data from the service element, and/or vice versa. According to some aspects of this disclosure, one or more of the address element and the service element may be stored remotely from the user device(s) 104A-N and user device(s) 106A-N and retrieved by one or more devices such as the user device and/or computing device(s) 108. According to some aspects of this disclosure, other information may be represented by the service element.

According to some aspects of this disclosure, computing device(s) 108 may be a device (and/or system), including, but not limited to, a server (e.g., web server, application server, content server, authentication/authorization server, etc.), cloud computing device, entity device, and/or content source in communication with user device(s) 104A-N, user device(s) 106A-N, and/or any other device and/or component of system 100. According to some aspects of this disclosure, computing device(s) 108 may communicate with user device(s) 104A-N, user device(s) 106A-N, and/or any other device and/or component of system 100 for providing data, content, and/or services. According to some aspects of this disclosure, computing device(s) 108 may facilitate, enable, and/or allow user device(s) 104A-N, user device(s) 106A-N, and/or any other device and/or component of system 100 to interact with remote resources such as data, devices, and files. According to some aspects of this disclosure, computing device(s) 108 may be configured as (or disposed at) a central location (e.g., a headend, processing facility, etc.), which may receive content (e.g., data, input, information, programming, web pages, applications, etc.) from multiple sources. According to some aspects of this disclosure, computing device(s) 108 may combine content from multiple sources and may distribute the content to user locations associated with user device(s) 104A-N, user device(s) 106A-N, and/or the like via a distribution system.

According to some aspects of this disclosure, user device(s) 104A-N, user device(s) 106A-N, and/or network devices 112 and 114 may be configured (e.g., via camouflage module, etc.) to camouflage user profiles, device identifiers, user indicators, browsing and/or communication traffic and/or information, and/or the like. For example, as shown, user device 104A may include a camouflage module 116. According to some aspects of this disclosure, user device 104A may be configured with camouflage module 116 by a service provider, a plugin, an application, and/or the like.

According to some aspects of this disclosure, camouflage module 116 may monitor and/or track data patterns (e.g., browsing history and/or activity, communications history and/or activity, etc.) associated with user device 104A and/or a user of user device 104A. For example, camouflage module 116 may include a store module and/or database 114 for storing a plurality of files indicative of monitored and/or tracked network and/or communication traffic (e.g., browsing history web pages visited, etc.), user identifiers, service elements, address elements, records, and/or other information. According to some aspects of this disclosure, camouflage module 116 may use and/or manipulate files and/or data indicative of monitored and/or tracked network and/or communication traffic to camouflage data associated with user device 104A. According to some aspects of this disclosure, camouflage module 116 may monitor and/or track data patterns (e.g., browsing history and/or activity, communications history and/or activity, etc.) associated with user device 104A and/or a user of user device 104A. According to some aspects of this disclosure, camouflage module 116 may include a store module and/or database 114 for storing a plurality of files indicative of monitored and/or tracked network traffic (e.g., browsing history web pages visited, etc.), user identifiers, service elements, address elements, records, and/or other information.

According to some aspects of this disclosure, camouflage module 116 may improve Internet security and/or the transmission of secure data. According to some aspects of this disclosure, camouflage module 116 may assist a user of user device 104A in avoiding “search-bubble” and/or “bubble effect” bias resulting from the inherent, personalized nature of Internet search engines that tailor results according to derived user preferences obtained through profiling. According to some aspects of this disclosure, camouflage module 116 may mitigate, counteract, and/or prevent user profiling (e.g., user data collection used to support/enable advertisement campaigns, media targeting, content targeting, product targeting, etc.) and/or data (e.g., credential information, sensitive information, cookies, emails, globally unique identifiers GUIDs, universally unique identifiers UUIDs, etc.) tracking through various techniques including, but not limited to, altering/modifying portions of user data to include different user data and/or faux user data, obscuring portions of user data, simulating user data, and/or the like.

According to some aspects of this disclosure, camouflage module 116 may include a trained machine-learning model/engine (e.g., a predictive model, etc.) and/or a specially configured analytics model that may forecast and/or generate user data (e.g., a plurality of simulated requests for a plurality of content items associated with a plurality of content sources, etc.). For example, according to some aspects of this disclosure, whenever user device 104A initiates communication to computing device(s) 108 and/or the like (e.g., Internet browsing on the internet, access of a web page, etc.), camouflage module 116 may generate (e.g., via forecasting by a predictive model, one or more algorithms/functions executed by an analytics model, etc.) simulated/faux data that resembles communication to computing device(s) 108 and/or the like (e.g., Internet browsing on the internet, access of a web page, etc.).

According to some aspects of this disclosure, camouflage model 116 may generate faux traffic, simulated data flows/streams, and/or the like based on browsing characteristics, tracking elements, fingerprinting data, interest information, and/or the like of user device 104A, another user device, and/or a simulated user device. According to some aspects of this disclosure, camouflage model 118 may dynamically adapt the type of faux traffic, simulated data flows/streams, and/or the like that is generated based on desired parameters and/or the user device and/or type of user device that is emulated. For example, faux traffic, simulated data flows/streams, and/or the like may be generated to imitate traffic from types of users such as a specific type of user or multiple types of users which allows the user's actual traffic to be obfuscated dynamically. According to some aspects of this disclosure, the faux traffic, simulated data flows/streams, and/or the like may be generated randomly (e.g., not based on any other traffic or user parameters). According to some aspects of this disclosure, the faux traffic, simulated data flows/streams, and/or the like may be based on traffic or user parameters of other user devices (e.g., one or more of user device(s) 104A-N or user device(s) 106A-N).

According to some aspects of this disclosure, camouflage model 116 may use its trained machine-learning model/engine (e.g., a predictive model, etc.) and/or a specially configured analytics model to forecast, calculate, and/or identify the types of traffic that more effectively obfuscate actual traffic. For example, a machine learning model of camouflage model 116 may be trained, for example through labeled data that identifies desired results used with various supervised and/or unsupervised training methods, to determine the simulated traffic that best hides the user's data. According to some aspects of this disclosure, the trained model may then feed these parameters to camouflage model 116 when generating the faux traffic, simulated data flows/streams, and/or the like for different users.

According to some aspects of this disclosure, whenever user device 104A initiates communication to computing device(s) 108 and/or the like (e.g., Internet browsing on the internet, access of a web page, etc.), camouflage module 116 may also initiate complex communications, such as complex Internet browsing, to computing device(s) 108 and/or the like. According to some aspects of this disclosure, simulated/faux data generated by camouflage module 116 may incorporate browsing characteristics, tracking elements, fingerprinting data, interest information, and/or the like that corresponds to the real/actual communication to computing device(s) 108 and/or the like.

For example, according to some aspects of this disclosure, cookies and the local storage data of user device 104A may be merged with simulated/faux data generated by camouflage module 116. According to some aspects of this disclosure, camouflage module 116 may use credentials associated with the user device 104A and/or a user of user device 104A and GUIDs to browse traffic check sites based on a predictive model (e.g., camouflage module 116, etc.) generated simulated data flow/stream of actual traffic/data from and/or associated with user device 104A to generate many (e.g., 10's-10,000's, etc.) digital twins while obfuscating the actual traffic/data from and/or associated with user device 104A in randomly generated simulated data flow/stream. As such, any third-party, unauthorized, and/or unwanted data trackers are forced to track the cookies and or local storage data of user device 104A and the simulated/faux data generated by camouflage module 116, thereby mitigating, counteracting, and/or prevent user profiling performed by any third-party, unauthorized, and/or unwanted data trackers. According to some aspects of this disclosure, each of user device(s) 104A-N and user device(s) 106A-N may include a respective camouflage module.

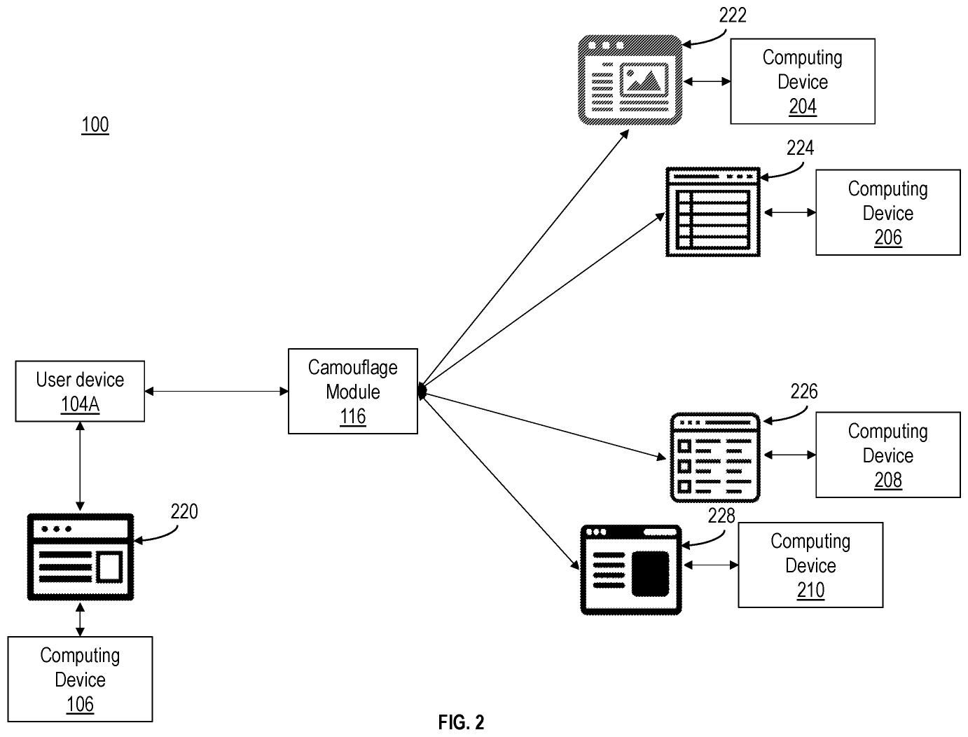

According to some aspects of this disclosure, FIG. 2 shows an example operation of camouflage module 116. According to some aspects of this disclosure, camouflage module 116 performs and/or executes a plurality of requests (e.g., during a single and/or multiple browsing sessions, etc.) for content (e.g., HTML files, content items, multimedia, online content, etc.) by navigating to and/or visiting a plurality of websites 222-228 hosted by and/or available via computing devices 204-210 (e.g., content sources, computing device(s) 106, etc.), respectively. According to some aspects of this disclosure, camouflage module 116 performs and/or executes a plurality of requests whenever user device 104A navigates, visits, and/or access a website 220 hosted by and/or available via computing device 106. According to some aspects of this disclosure, when camouflage module 116 navigates, visits, and/or accesses websites 222-228, camouflage module 116 may collect and/or accumulate user-specific data from each website. For example, according to some aspects of this disclosure, camouflage module 116 may collect and/or accumulate whatever cookies and other user-specific data may be set by each of websites 222-228. According to some aspects of this disclosure, camouflage module 116 may repeat this behavior for any number of different and/or varying websites with different and varying characteristics. According to some aspects of this disclosure, camouflage module 116 may collect and/or accumulate user-specific data corresponding to a particular browsing history or pattern. The user-specific data may be stored by camouflage module 116 as a user profile. According to some aspects of this disclosure, camouflage module 116 may repeat the described operations to generate a plurality of simulated user profiles. According to some aspects of this disclosure, the collected data may be fed to the trained model to improve the simulated traffic for that particular user.

According to some aspects of this disclosure, websites navigated, visited, and/or accessed by camouflage module 116 may be selected by methods/techniques including, but not limited to, based on target demographic group, random sampling of top websites, and/or the like. According to some aspects of this disclosure, websites navigated, visited, and/or accessed by camouflage module 116 may be selected to simulate a forecasted and/or expected communication behavior of a target demographic and/or a user of user device 104A.

According to some aspects of this disclosure, websites 222-228 may be actual and/or real websites. According to some aspects of this disclosure, websites 222-228 may be simulated and data may include headers and/or metadata that simulate navigation to, a visit to, and/or access to a website. According to some aspects, based on the disclosure, other techniques will also become apparent to those skilled in the art.

According to some aspects of this disclosure, when camouflage module 116 may perform additional actions during or after a webpage is loaded by user device 104A. According to some aspects of this disclosure, additional actions may include, but are not limited to, altering GUIDs, modifying telemetry data, and/or otherwise influencing the behavior of a website, for example, via code injection, GUID modification, GUID removal (e.g., to preserve user privacy, to secure private and/or sensitive information, etc.), and/or the like.

Returning to FIG. 1, according to some aspects of this disclosure, network devices 112 and 114 may each be configured to perform the same and/or similar operations as each of user device(s) 104A-N and user device(s) 106A-N, for example via a respective camouflage module (e.g., camouflage module 116, etc.). According to some aspects, network devices 112 and 114 may each be configured to camouflage user data associated with respective user locations and/or one or more user devices at a particular location. For example, network devices 112 and 114 may be associated with different locations and may camouflage user data associated with the respective locations such as user device(s) 104A-N and user device(s) 106A-N, respectively. For example, network device 112, shown in greater detail than network device includes camouflage module 118 for camouflaging user data associated with user device(s) 104A-N.

According to some aspects of this disclosure, to camouflage user data associated with a particular location, for example, a location where user device(s) 104A-N may be located and/or associated, camouflage module 118 may identify a data pattern (e.g., browsing history and/or activity, previous communications, etc.) for either of user device(s) 104A-N at a first location and may communicate with a camouflage module configured with network device 114 to obtain a data pattern for either of user device(s) 106A-N at a second location (and/or vice versa).

According to some aspects of this disclosure, camouflage module 118 may modify the data pattern for either of user device(s) 104A-N to indicate an identifier (e.g., hostname, etc.) of either of user device(s) 106A-N and an identifier (e.g., source IP address, etc.) of a location and/or origin associated with either of user device(s) 106A-N (and/or vice versa).

According to some aspects of this disclosure, camouflage module 118 may receive requests from either of user device(s) 104A-N for content (e.g., a resource, an HTML file, a web page, an application, etc.) from a content source (e.g., a web server, an application server, computing device(s) 108, etc.). According to some aspects of this disclosure, camouflage module 118 may one or more of the requests for content to indicate an identifier of a different user device (e.g, a user device at a third location (not shown), either of user device(s) 106A-N, etc.) and an identifier of a different location and/or origin (e.g., a third location (not shown), the location associated with either of user device(s) 106A-N, etc.).

According to some aspects of this disclosure, camouflage module 118 may output a data stream that includes modified data patterns for either of user device(s) 104A-N and modified requests for the content received from either of user device(s) 104A-N. According to some aspects of this disclosure, the data stream output by camouflage module 118 may also include a plurality of simulated requests for a plurality of content items associated with a plurality of content sources that are generated, for example, by a predictive model based on data patterns for either of user device(s) 104A-N, either of user device(s) 106A-N, and/or the like.

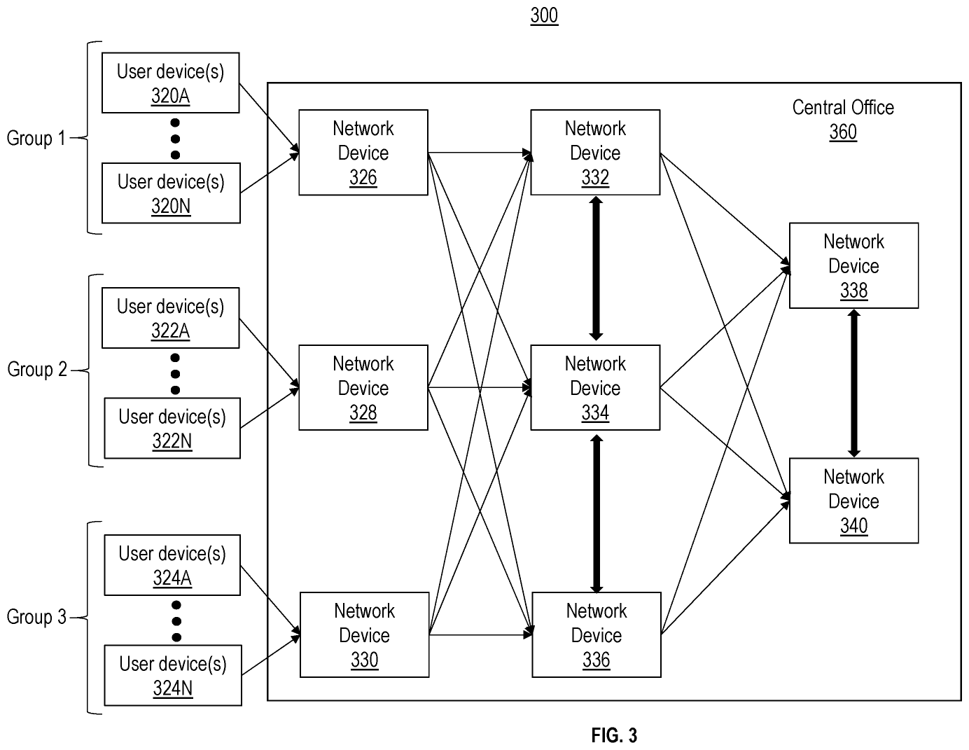

According to some aspects of this disclosure, the system 100 of FIG. 1 and/or a similar system comprising devices configured with camouflage modules may be scaled to accommodate and/or support camouflaging user data for a vast number of user devices. According to some aspects of this disclosure, FIG. 3 shows an example system 300 comprising devices with camouflage modules and/or supported by camouflage modules in a scaled environment to accommodate and/or support camouflaging user data. According to some aspects of this disclosure, system 300 is merely an example of one suitable system environment and is not intended to suggest any limitation as to the scope of use or functionality of aspects described herein. Neither should system 300 be interpreted as having any dependency or requirement related to any single module/component or combination of modules/components described therein. According to some aspects of this disclosure, aspects of system 300 may include and/or operate with software, hardware, combinations thereof, and/or the like.

According to some aspects of this disclosure, system 300, Group 1-Group 3 may each include a plurality of locations. According to some aspects of this disclosure, each location may be associated with, for example, a local area network, a private network, a user network, and/or the like. According to some aspects of this disclosure, each local area network, private network, user network, and/or the like may be associated with a different house, a business, and/or the like. According to some aspects of this disclosure, each local area network, private network, user network, and/or the like may include one or more user devices. For example, Group 1 may include user device(s) 320A to 320N, Group 2 may include user device(s) 322A to 322N, and Group 3 may include user device(s) 324A to 324N. According to some aspects of this disclosure, user devices from Groups 1-3 may each include camouflage modules. According to some aspects of this disclosure, each local area network, private network, user network, and/or the like of a group (e.g., Groups 1-3, etc.) may be connected via fiber optics and/or another high-speed transmission medium.

According to some aspects of this disclosure, each group (e.g., Groups 1-3, etc.) may be connected and/or in communication with a network device. For example, user devices of Group 1 may be connected and/or be in communication with a network device 326, user devices of Group 2 may be connected and/or in communication with a network device 328, and user devices of Group 3 may be connected and/or in communication with a network device 330. According to some aspects of this disclosure, network devices 326-330 may include optical line terminals (OLTs) and/or the like and may each include camouflage modules. According to some aspects of this disclosure, network devices 326-330 may support and/or service a plurality (e.g., between 1K-4K, etc.) of local area networks, private networks, user networks, and/or the like.

According to some aspects of this disclosure, network devices 326-330 may each connect to and/or be in communication with network devices 332-336. According to some aspects of this disclosure, network devices 332-336 may include spine routers and/or the like. According to some aspects of this disclosure, network devices 332-336 may each include camouflage modules. According to some aspects of this disclosure, network devices 332-336 may support and/or service a plurality (e.g., between 1K-4K, etc.) of OLTs (e.g., network devices 326-330, etc.) and/or the like.

According to some aspects of this disclosure, network devices 332-336 may each connect to and/or be in communication with network devices 338-340. According to some aspects of this disclosure, network devices 338-340 may include broadband network gateways and/or the like. According to some aspects of this disclosure, network devices 338-340 may each include camouflage modules.

According to some aspects of this disclosure, network devices 326-340 may utilize respective camouflage modules to perform deep packet investigation (DPI) of user data originating from Groups 1-3. According to some aspects of this disclosure, DPI may be used to analyze data packets to identify information such as where packets originate from (e.g., source ports, etc.) and/or where they are destined (e.g., destination ports, etc.). According to some aspects of this disclosure, DPI may be used within system 300 to create a “carrier grade like” localized network address translation (NAT) to camouflage and/or obfuscate user data as described herein. For example, the camouflage module of a network device may identify which cookies are being downloaded by a user device in communication with the network device. According to some aspects of this disclosure identified cookies may be swapped and/or impersonated.

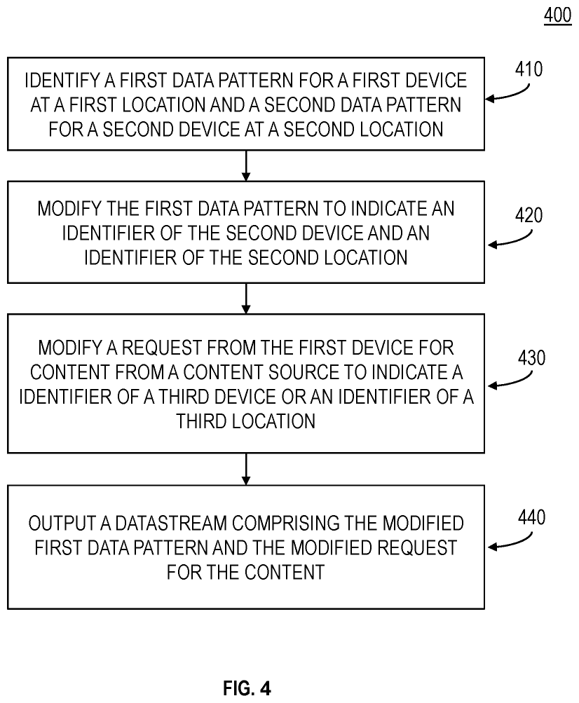

FIG. 4 is a flowchart for a method 400 for camouflaging user data, according to some aspects of this disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-2. However, method 400 is not limited to described aspects of FIGS. 1-3.

In 410, network device 112 identifies a first data pattern for a first device at a first location and a second data pattern for a second device at a second location. According to some aspects of this disclosure, the first data pattern and the second data pattern may each include additional requests for content from the content source or one or more requests for additional content from additional content sources.

In 420, network device 112 modifies the first data pattern to indicate an identifier of the second device and an identifier of the second location.

In 430, network device 112 modifies a request from the first device for content from a content source to indicate an identifier of a third device and/or an identifier of a third location.

In 440, network device 112 outputs a data stream comprising the modified first data pattern and the modified request for the content. According to some aspects of this disclosure, network device 112 outputs the data stream that includes the modified first data pattern and the modified request for the content by sending at least a portion of the data stream, for example, the modified request for the content, to the content source. According to some aspects of this disclosure, network device 112 outputs the data stream that includes the modified first data pattern and the modified request for the content by sending the content to the first device based on the content being received from the content source and an identifier of the first device mapped to the modified request for the content.

According to some aspects of this disclosure, method 400 may further include network device 112 modifying the second data pattern to indicate an identifier of the first device and an identifier of the first location, an identifier of another device and an identifier of another location, and/or the like. According to some aspects of this disclosure, the data stream output by network device 112 may also include the modified second data pattern.

According to some aspects of this disclosure, method 400 may further include network device 112 generating a plurality of simulated requests for a plurality of content items associated with a plurality of content sources. According to some aspects of this disclosure, network device 112 generates the plurality of simulated requests for the plurality of content items associated with the plurality of content sources based on at least one of the first data pattern or the second data pattern. For example, a predictive model trained to generate simulated data may use the first data pattern and/or the second data pattern to generate the plurality of simulated requests for the plurality of content items associated with the plurality of content sources. According to some aspects of this disclosure, the data stream output by network device 112 may also include further the plurality of simulated requests.

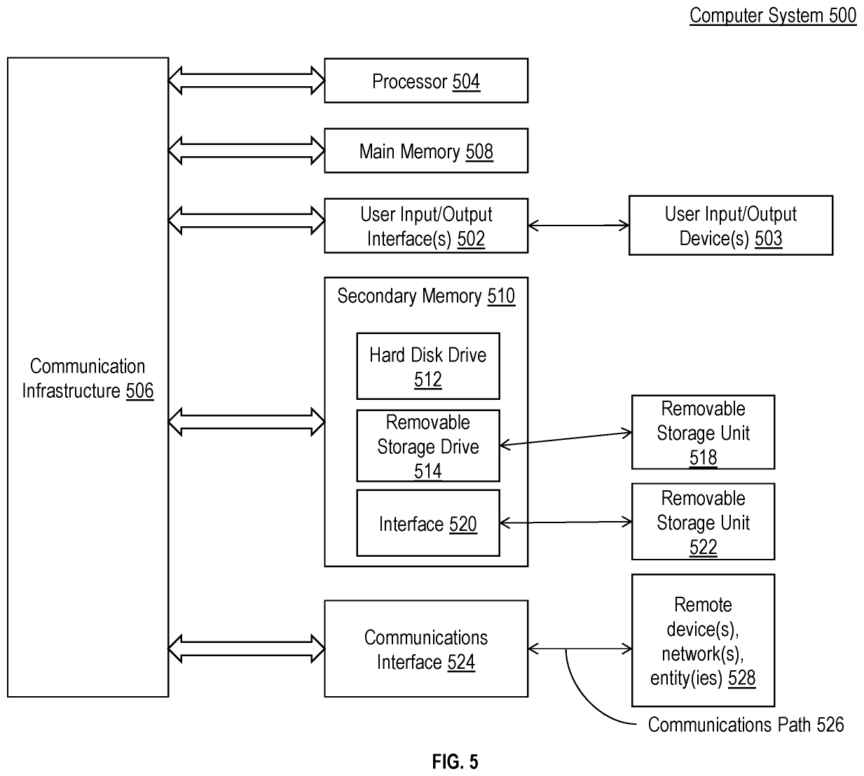

FIG. 5 is an example computer system useful for implementing various embodiments. Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof. According to some aspects of this disclosure, user device(s) 104A-N, user device(s) 106A-N, computing device(s) 108, and/or network devices 110 and 112 of FIG. 1 (and/or any other device/component described herein) may be implemented using the computer system 500. According to some aspects of this disclosure, the computer system 500 may be used to implement method 400 and/or any other methods and/or steps described herein.

Computer system 500 may include one or more processors (also called central processing units, or CPUs), such as a processor 504. Processor 504 may be connected to a communication infrastructure or bus 506.

Computer system 500 may also include user input/output device(s) 502, such as monitors, keyboards, pointing devices, etc., which may communicate with communication infrastructure or bus 506 through user input/output device(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, integrated circuit technologies (e.g., ASIC, FPGA, etc), and/or the like.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, a tape backup device, and/or any other storage device/drive.

Removable storage drive 514 may interact with a removable storage unit 518. The removable storage unit 518 may include a computer-usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to the removable storage unit 518.

Secondary memory 510 may include other means, devices, components, instrumentalities, and/or other approaches for allowing computer programs and/or other instructions and/or data to be accessed by computer system 500. Such means, devices, components, instrumentalities, and/or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
identifying a first data pattern for a first device at a first location and a second data pattern for a second device at a second location;
modifying the first data pattern to indicate an identifier of the second device and an identifier of the second location;
modifying a request from the first device for content from a content source to indicate at least one of an identifier of a third device or an identifier of a third location; and
outputting a data stream comprising the modified first data pattern and the modified request for the content.

2. The method of claim 1, wherein the first data pattern and the second data pattern each comprise at least one of additional requests for the content from the content source or requests for additional content from additional content sources.

3. The method of claim 1, wherein the outputting the data stream further comprises sending, to the content source, the modified request for the content.

4. The method of claim 3, further comprising sending, based on the content received from the content source and an identifier of the first device mapped to the modified request for the content, the content to the first device.

5. The method of claim 1, further comprising:
modifying the second data pattern to indicate an identifier of the first device, an identifier of the first location, an identifier of another device, or an identifier of another location,
wherein the data stream further comprises the modified second data pattern.

6. The method of claim 1, further comprising generating, based on at least one of the first data pattern or the second data pattern, a plurality of simulated requests for a plurality of content items associated with a plurality of content sources, wherein the data stream further comprises the plurality of simulated requests.

7. The method of claim 1, wherein demographic information for at least one of the first data pattern or the second data pattern matches demographic information for at least a portion of the plurality of simulated requests.

8. A system comprising:
a memory; and
at least one processor coupled to the memory and configured to perform operations comprising:
identifying a first data pattern for a first device at a first location and a second data pattern for a second device at a second location;
modifying the first data pattern to indicate an identifier of the second device and an identifier of the second location;
modifying a request from the first device for content from a content source to indicate at least one of an identifier of a third device or an identifier of a third location; and
outputting a data stream comprising the modified first data pattern and the modified request for the content.

9. The system of claim 8, wherein the first data pattern and the second data pattern each comprise at least one of additional requests for the content from the content source or requests for additional content from additional content sources.

10. The system of claim 8, wherein the outputting the data stream further comprises sending, to the content source the modified request for the content.

11. The system of claim 10, the operations further comprising:
sending, based on the content received from the content source and an identifier of the first device mapped to the modified request for the content, the content to the first device.

12. The system of claim 8, the operations further comprising:
modifying the second data pattern to indicate an identifier of the first device, an identifier of the first location, an identifier of another device, or an identifier of another location,
wherein the data stream further comprises the modified second data pattern.

13. The system of claim 8, the operations further comprising:
generating, based on at least one of the first data pattern or the second data pattern, a plurality of simulated requests for a plurality of content items associated with a plurality of content sources,
wherein the data stream further comprises the plurality of simulated requests.

14. The system of claim 8, wherein demographic information for at least one of the first data pattern or the second data pattern matches demographic information for at least a portion of the plurality of simulated requests.

15. A non-transitory computer-readable medium having instructions stored thereon that, when executed by at least one computing device, cause the at least one computing device to perform operations comprising:
identifying a first data pattern for a first device at a first location and a second data pattern for a second device at a second location;
modifying the first data pattern to indicate an identifier of the second device and an identifier of the second location;
modifying a request from the first device for content from a content source to indicate at least one of an identifier of a third device or an identifier of a third location; and
outputting a data stream comprising the modified first data pattern and the modified request for the content.

16. The non-transitory computer-readable medium of claim 15, wherein the first data pattern and the second data pattern each comprise at least one of additional requests for the content from the content source or requests for additional content from additional content sources.

17. The non-transitory computer-readable medium of claim 15, wherein the outputting the data stream further comprises sending, to the content source, the modified request for the content.

18. The non-transitory computer-readable medium of claim 15, the operations further comprising:
sending, based on the content received from the content source and an identifier of the first device mapped to the modified request for the content, the content to the first device.

19. The non-transitory computer-readable medium of claim 18, the operations further comprising:
modifying the second data pattern to indicate an identifier of the first device, an identifier of the first location, an identifier of another device, or an identifier of another location,
wherein the data stream further comprises the modified second data pattern.

20. The non-transitory computer-readable medium of claim 15, the operations further comprising:
generating, based on at least one of the first data pattern or the second data pattern, a plurality of simulated requests for a plurality of content items associated with a plurality of content sources,
wherein the data stream further comprises the plurality of simulated requests.
